(19) United States
(12) Patent Application Publication
(10) Pub. No.: US 2014/0106679 A1
(43) Pub. Date: Apr. 17, 2014

(54) WIRELESS COMMUNICATION SYSTEM, RECEIVER

(71) Applicant: Tomohiro Kanauchi, Tokyo (JP)

(72) Inventor: Tomohiro Kanauchi, Tokyo (JP)

(21) Appl. No.: 14/124,191

(22) PCT Filed: Jun. 6, 2012
(86) PCT No.: PCT/JP2012/064600

§ 371 Date: Dec. 5, 2013

(30) Foreign Application Priority Data
Jun. 8, 2011 (JP) 2011-128011

(51) Int. Cl. H04B 1/04; H04B 1/40; H04B 17/00

(52) U.S. Cl. CPC H04B 1/0475; H04B 17/0067; H04B 1/40
USPC 455/63.1; 455/226.3

(57) ABSTRACT

In a wireless communication system including a transmitter and a receiver, the receiver includes a signal-to-noise ratio (SNR) calculation unit which calculates an SNR of a baseband signal of a signal received from the transmitter, and an indication information generation unit which generates transmission strength indication information indicating transmit power of the transmitter based on a history of the SNR calculated by the SNR calculation unit, and the transmitter includes a transmission unit which controls the transmit power based on the SNR.

### TECHNICAL FIELD

The present invention relates to a wireless communication system and a receiver.

### BACKGROUND ART

When a transmission path characteristic (transmission path information) has been degraded in a wireless communication device of the related art, automatic transmitter power control (ATPC) may be used to further increase an output of a transmitter than before the degradation. As disclosed in Patent Document 1, a wireless communication device includes an output level detection timer which controls an output level of a transmission unit in a control value set in a transmission side according to a reception input level detected by a reception side and sets a first predetermined time in which the transmission unit is allowed to be in an excessive control state, an output level control value setting means which outputs a predetermined control value used to control the output level, and an output level detection means which sets the control value to the predetermined control value after the first predetermined time has elapsed.

### DOCUMENT OF THE PRIOR ART

### Patent Document

[Patent Document 1]

Japanese Unexamined Patent Application, First Publication No. 2004-266552

### DISCLOSURE OF INVENTION

### Problems to be Solved by the Invention

Incidentally, because there is a distortion characteristic that distortion increases when the transmitter increases transmit power, a desired to undesired signal (D/U) ratio of a transmission signal increases. Here, the distortion characteristic of the transmitter is also varied due to a plurality of other factors such as the number of transmission frequencies, the temperature of the transmitter, and variation in a transmission circuit.

However, even when these factors overlap in the transmitter of the related art, it is necessary to limit the output of the transmitter to a low level with a margin so that the D/U ratio can be secured. That is, there is a problem in that the output of the transmitter is limited to be low even when the output of the transmitter can be increased without degrading the D/U ratio in the transmitter of the related art.

The present invention has been made in view of the above-described points, and provides a wireless communication system and a receiver capable of increasing a transmitter's output without degrading the signal-to-noise ratio (SNR).

### Means for Solving the Problem

(1) The present invention has been made to solve the above-described problem. According to an aspect of the present invention, there is provided a wireless communication system including a transmitter and a receiver, wherein the receiver includes: an SNR calculation unit which calculates an SNR of a baseband signal of a signal received from the transmitter; and an indication information generation unit which generates transmission strength indication information indicating transmit power of the transmitter based on a history of the SNR calculated by the SNR calculation unit, and wherein the transmitter includes: a transmission unit which controls the transmit power based on the SNR

(2) According to the aspect of the present invention, in the above-described wireless communication system, the receiver includes: an antenna which transmits and receives radio waves to and from the transmitter; a reception unit which converts the radio waves received by the antenna into a baseband signal; a storage unit which stores a past SNR and past transmission strength indication information; an SNR comparison unit which compares a current SNR and current transmission strength indication information to the past SNR and the past transmission strength indication information; and an indication information generation unit which generates transmission strength indication information indicating the transmit power of the transmitter based on a comparison result of the SNR comparison unit, the transmitter includes: an indication information extraction unit which acquires the transmission strength indication information generated by the receiver, and the transmission unit controls the transmit power based on the transmission strength indication information input from the indication information extraction unit.

(3) According to the aspect of the present invention, in the above-described wireless communication system, the SNR calculation unit calculates the SNR based on a signal after a Fourier transform on the baseband signal.

(4) According to the aspect of the present invention, the above-described wireless communication system further includes: a demodulation unit which demodulates the baseband signal, wherein the SNR calculation unit calculates the SNR based on a signal point error of a signal demodulated by the demodulation unit.

(5) According to the aspect of the present invention, the above-described wireless communication system further includes: an output-of-transmitter determination unit which generates the transmission strength indication information based on a transmission output of the transmitter.

(6) According to the aspect of the present invention, the above-described wireless communication system further includes: a transmission path information comparison unit which generates the transmission strength indication information based on variation in transmission path information.

(7) According to an aspect of the present invention, there is provided a receiver including: an SNR calculation unit which calculates an SNR of a baseband signal of a signal received from a transmitter; and an indication information generation unit which generates transmission strength indication information indicating transmit power of the transmitter based on a history of the SNR calculated by the SNR calculation unit.

### Effect of the Invention

According to the present invention, an output of a transmitter can be increased without degrading an SNR.

### BRIEF DESCRIPTION OF DRAWINGS

FIG. 1 is a block diagram of a wireless communication system according to a first embodiment of the present invention.

FIG. 2 is a flowchart illustrating an example of an operation according to the first embodiment of the present invention.

FIG. 3 is a flowchart illustrating an example of an operation according to the first embodiment of the present invention.

FIG. 4 is a flowchart illustrating an example of an operation according to the first embodiment of the present invention.

FIG. 5 is a block diagram of a wireless communication system according to a second embodiment of the present invention.

FIG. 6 is a flowchart illustrating an example of an operation according to the second embodiment of the present invention.

FIG. 7 is a block diagram of a wireless communication system according to a third embodiment of the present invention.

FIG. 8 is a flowchart illustrating an example of an operation according to the third embodiment of the present invention.

FIG. 9 is a flowchart illustrating an example of an operation according to the third embodiment of the present invention.

### EMBODIMENTS FOR CARRYING OUT THE INVENTION

### First Embodiment

Hereinafter, the first embodiment of the present invention will be described in detail with reference to the drawings.

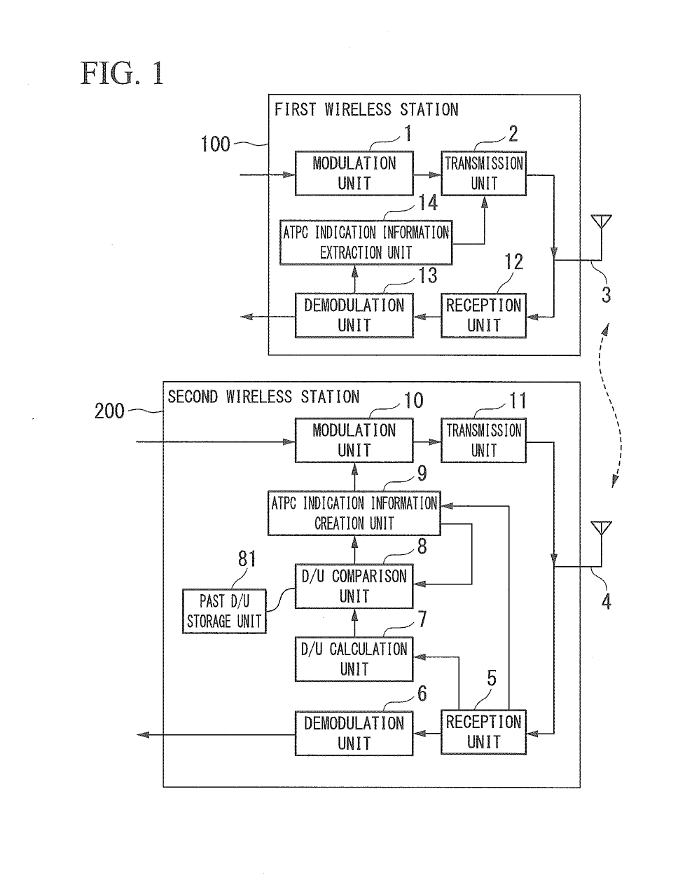

FIG. 1 is a block diagram illustrating a wireless communication system 1a according to the first embodiment of the present invention.

The wireless communication system 1a includes a first wireless station 100 and a second wireless station 200.

The first wireless station 100 includes a modulation unit 1, a transmission unit 2, an antenna 3, a reception unit 12, a demodulation unit 13, and an ATPC indication information extraction unit 14.

The modulation unit 1 modulates input transmission information and outputs a modulated modulation signal to the transmission unit 2.

The transmission unit 2 converts the modulation signal input from the modulation unit 1 into a radio frequency (RF) signal of strength indicated by ATPC indication information input from an ATPC indication information extraction unit 14. Here, the ATPC indication information is information indicating the strength of the RF signal output by the transmission unit 2. The transmission unit 2 outputs the RF signal obtained by the conversion to the antenna 3.

The antenna 3 transmits the RF signal input from the transmission unit 2 to the second wireless station 200. The antenna 3 receives the RF signal transmitted from the wireless station 200, and outputs the received RF signal to the reception unit 12.

The reception unit 12 converts the RF signal input from the antenna 3 into a baseband signal, and outputs the baseband signal obtained by the conversion to the demodulation unit 13.

The demodulation unit 13 demodulates the baseband signal input from the reception unit 12 into transmission information. The demodulation unit 13 extracts control information from the transmission information and outputs the extracted control information to the ATPC indication information extraction unit 14.

The ATPC indication information extraction unit 14 extracts the ATPC indication information from the control information input from the demodulation unit 13, and outputs the extracted ATPC indication information to the transmission unit 2.

The second wireless station 200 includes an antenna 4, a reception unit 5, a demodulation unit 6, a D/U calculation unit 7, a D/U comparison unit 8, an ATPC indication information creation unit 9, a modulation unit 10, a transmission unit 11, and a past D/U storage unit 81.

The antenna 4 transmits the RF signal input from the transmission unit 11 to the first wireless station 100. The antenna 4 receives the RF signal transmitted from the second wireless station 200, and outputs the received RF signal to the reception unit 5.

The reception unit 5 converts the RF signal input from the antenna 4 into a baseband signal, and outputs the baseband signal obtained by the conversion to the demodulation unit 6 and the D/U calculation unit 7. The reception unit 5 measures the strength of the RF signal received by the antenna 4, and outputs a received electric field strength signal indicating the measured strength to the ATPC indication information creation unit 9.

The demodulation unit 6 demodulates the baseband signal input from the reception unit 5 into transmission information. The demodulation unit 6 outputs the transmission information obtained by the demodulation.

The D/U calculation unit 7 (SNR calculation unit) performs a fast Fourier transform (FFT) process on the baseband signal input from the reception unit 5. The D/U calculation unit 7 calculates each of powers of baseband signals of desired and undesired bands of a signal, and calculates a D/U ratio (SNR) which is the ratio therebetween. The D/U calculation unit 7 outputs D/U ratio information indicating the calculated D/U ratio to the D/U comparison unit 8.

The D/U comparison unit 8 (SNR comparison unit) receives the D/U ratio information from the D/U calculation unit 7. The D/U comparison unit 8 receives the ATPC indication information from the ATPC indication information creation unit 9. The D/U comparison unit 8 reads past D/U ratio information and past output-of-transmitter information recorded on the past D/U storage unit 81. The D/U comparison unit 8 generates output-of-transmitter limitation information for limiting the strength of an RF signal to be transmitted from the transmission unit 2 of the first wireless station 100 by comparing the latest D/U ratio and the latest D/U ratio indicated by the ATPC indication information to a past D/U ratio indicated by past D/U ratio information and a past output of the transmitter indicated by past output-of-transmitter information. That is, the D/U calculation unit 7 generates the output-of-transmitter limitation information based on a D/U ratio history and an output-of-transmitter history. The D/U comparison unit 8 outputs the D/U ratio information and the generated output-of-transmitter limitation information to the ATPC indication information creation unit 9. In addition, the D/U comparison unit 8 causes the latest D/U ratio information and the latest output-of-transmitter information to be stored in the past D/U storage unit 81.

The ATPC indication information creation unit (indication information generation unit) 9 generates ATPC indication information based on the received electric field strength information input from the reception unit 5 and the output-of-transmitter limitation information input from the D/U comparison unit 8. The ATPC indication information creation unit 9 outputs the generated ATPC indication information to the modulation unit 10 and the D/U comparison unit 8.

The modulation unit 10 modulates the input transmission information and the ATPC indication information input from the ATPC indication information creation unit 9 and outputs a modulated modulation signal to the transmission unit 11.

The transmission unit 11 converts the modulation signal input from the modulation unit 10 into an RF signal, and outputs the RF signal to the antenna 4.

The past D/U storage unit 81 stores a table in which the past D/U ratio information and the output-of-transmitter information indicating the output of the transmitter are associated. When the number of records of the stored table has exceeded a predetermined number, the past D/U storage unit 81 deletes old records corresponding to an excess of records beyond the predetermined number, and holds a predetermined number of records.

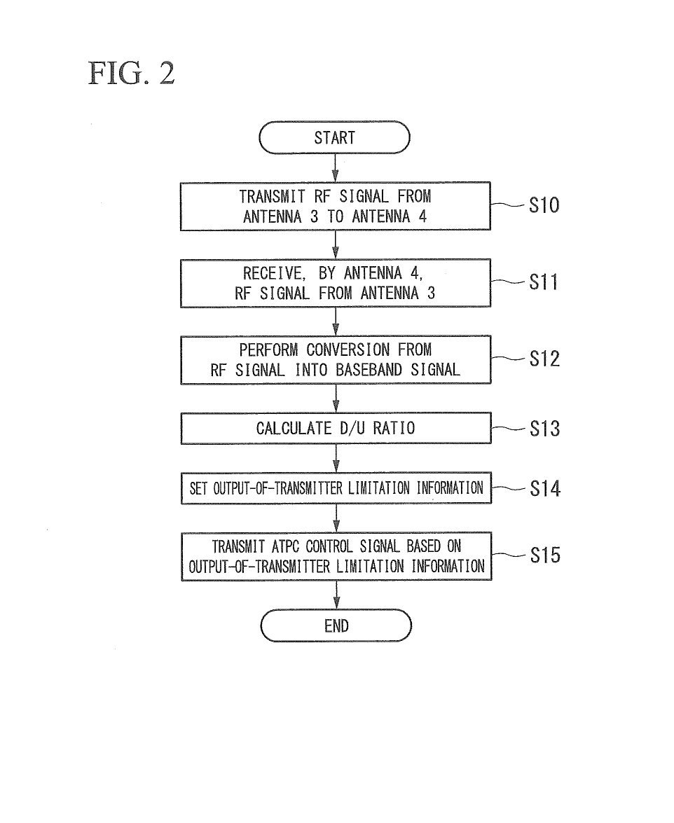

FIG. 2 is a flowchart illustrating an example of an operation according to the first embodiment.

(Step S10)

The antenna 3 transmits an RF signal input from the transmission unit 2 to the second wireless station 200. Thereafter, the process proceeds to step S11.

(Step S11)

The antenna 4 receives the RF signal transmitted from the first wireless station 100. The antenna 4 outputs the received RF signal to the reception unit 5. Thereafter, the process proceeds to step S12.

(Step S12)

The reception unit 5 converts the RF signal input from the antenna 4 into a baseband signal. The reception unit 5 measures the strength of the RF signal received by the antenna 4. Thereafter, the process proceeds to step S13.

(Step S13)

The D/U calculation unit 7 generates a baseband signal (referred to as a section baseband signal) of a predetermined fixed time from the baseband signal obtained by the conversion in step S12. The D/U calculation unit 7 performs an FFT process on the section baseband signal, and calculates I(ω) which is a signal amplitude in a frequency domain of the section baseband signal.

The D/U calculation unit 7 calculates signal strengths of baseband signals of desired and undesired bands from I(ω) indicating the signal amplitude in the frequency domain obtained from a result of the FFT process. The D/U calculation unit 7 calculates a D/U ratio based on a difference between the calculated signal strengths.

Specifically, assuming that a center frequency of the desired band is ω₀ and a width of the desired band is Δω, the D/U calculation unit 7 calculates signal strength D of a baseband signal of the desired band at ω satisfying ω₀−1/2Δω≦ω≦ω₀+1/2Δω according to Equation (1).

D=∫_{ω}_{₀}_{-1/2Δω}^{ω}^{₀}^{+1/2Δω}|I(ω)|²dω (1)

Also, Δω is a predetermined value. In addition, the D/U calculation unit 7 calculates the signal strength U of the baseband signal of the undesired band according to Equation (2).

U=∫ₐ^{ω}^{₀}^{-1/2Δω}|I(ω)|²dω+∫_{ω}_{₀}_{1/2Δω}^{b}|I(ω)|²dω (2)

Here, a is a lower frequency when the signal strength of the undesired band is calculated. The D/U calculation unit 7 pre-stores a satisfying 0≦a≦ω₀+1/2Δω. In addition, b is an upper frequency when the signal strength of the undesired band is calculated. The D/U calculation unit 7 pre-stores b satisfying ω₀+1/2Δω≦β.

The D/U calculation unit 7 outputs D/U ratio information indicating a D/U ratio, which is a value obtained by dividing D shown in Equation (1) by U shown in Equation (2), to the D/U comparison unit 8. Thereafter, the process proceeds to step S14.

(Step S14)

The D/U comparison unit 8 generates output-of-transmitter limitation information based on an output-of-transmitter history, a D/U ratio history, a current output of the transmitter, and a current D/U ratio. Also, details of step S14 will be described later.

(Step S15)

Based on output-of-transmitter limitation information transmitted from the second wireless station 200, the ATPC indication information extraction unit 14 controls the strength of the RF signal output by the transmission unit 2. Also, details of step S15 will be described later.

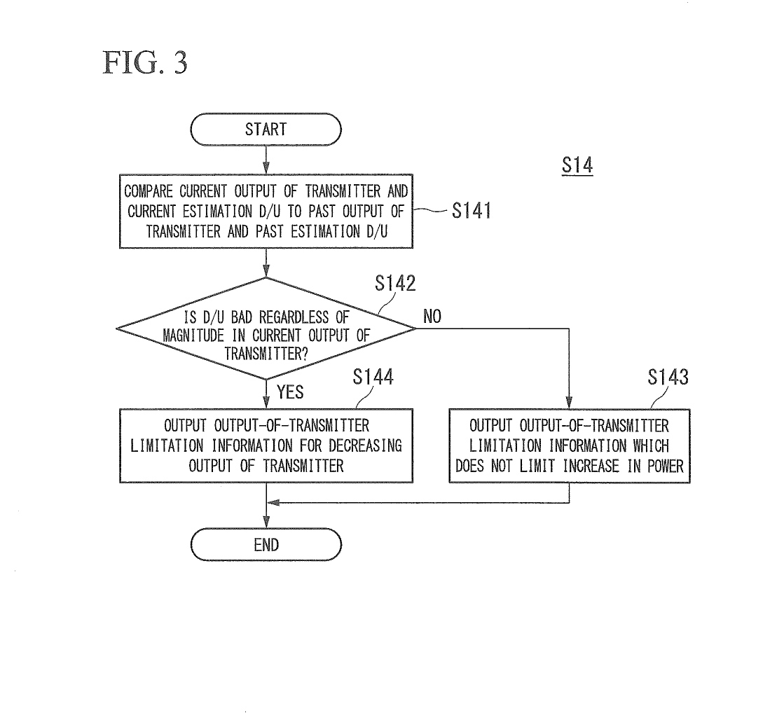

FIG. 3 is a flowchart illustrating an example of an operation according to the first embodiment. This flowchart is a detailed description of the process of step S14 in FIG. 2.

(Step S141)

The D/U comparison unit 8 receives ATPC indication information from the ATPC indication information creation unit 9, and extracts a record of an output of the transmitter higher than a current output of the transmitter indicated by the ATPC indication information from the table stored by the past D/U storage unit 81. The D/U comparison unit 8 calculates a value d(D/U) obtained by subtracting a current D/U ratio indicated by the current D/U ratio information input from the D/U calculation unit 7 from the highest ratio of past D/U ratios included in respective extracted records. The D/U comparison unit 8 writes the current output of the transmitter and the current D/U ratio to the past D/U storage unit 81. Thereafter, the process proceeds to step S142.

(Step S142)

The D/U comparison unit 8 determines whether d(D/U) calculated in step S14 is less than 0. When it is determined that d(D/U) is less than 0 (Yes), the process proceeds to step S144. When it is determined that d(D/u) is greater than or equal to 0 (No), the process proceeds to step S143.

(Step S143)

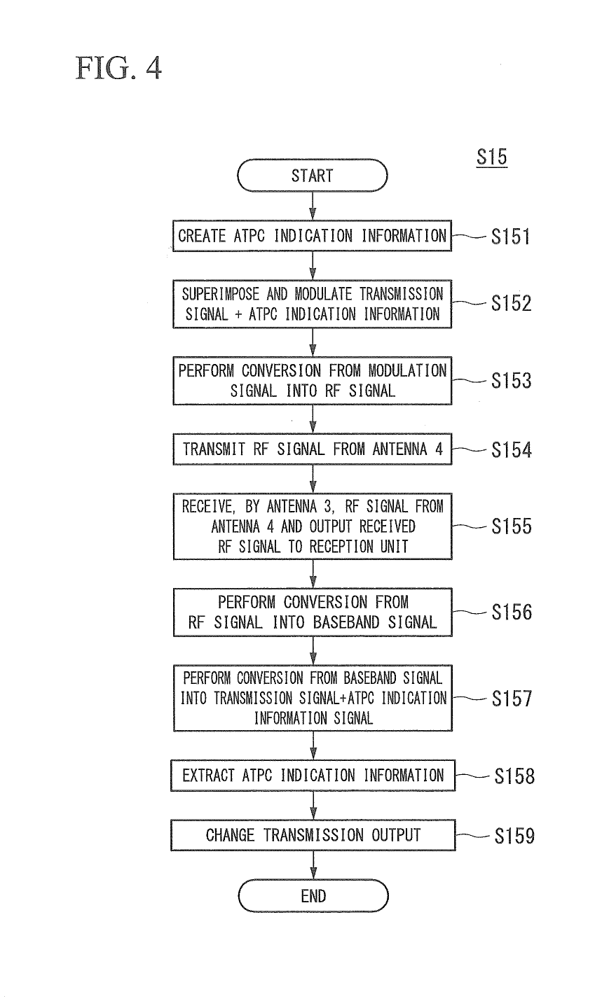

The D/U comparison unit 8 generates output-of-transmitter limitation information which does not limit an increase in power of the transmitter of the transmission unit 2. Thereafter, the process proceeds to a start process of FIG. 4.

(Step S144)

The D/U comparison unit 8 generates output-of-transmitter limitation information to decrease the power of the transmitter of the transmission unit 2. Thereafter, the process proceeds to the start process of FIG. 4.

FIG. 4 is a flowchart illustrating an example of an operation according to the first embodiment. This flowchart is a detailed description of the process of step S15 in FIG. 2.

(Step S151)

The ATPC indication information creation unit 9 outputs ATPC indication information to the modulation unit 10 based on the output-of-transmitter limitation information generated in step S143 and the strength (received electric field strength) of the RF signal measured in step S12.

Specifically, when the received electric field strength is less than a predetermined lower limit threshold value of reception strength, the ATPC indication information creation unit 9 generates ATPC indication information indicating a value, for example, which is 1% higher than the current power of the transmitter of the transmission unit 2. When the received electric field strength is greater than a predetermined upper limit threshold value of the reception strength, the ATPC indication information creation unit 9 generates ATPC indication information indicating a value, for example, which is 1% lower than the current power of the transmitter of the transmission unit 2.

The ATPC indication information creation unit 9 generates ATPC indication information based on the output-of-transmitter limitation information generated in step S144 and the strength (received electric field strength) of the RF signal measured in step S12.

Specifically, when the received electric field strength is greater than the predetermined upper limit threshold value of the reception strength, the ATPC indication information creation unit 9 generates ATPC indication information indicating a value, for example, which is 1% lower than the current power of the transmitter of the transmission unit 2. When the received electric field strength is less than the predetermined upper limit threshold value of the reception strength, the ATPC indication information to maintain the current power of the transmission unit 2 is generated. Thereafter, the process proceeds to step S152.

(Step S152)

The modulation unit 10 modulates the input transmission information and the ATPC indication information generated in step S151 after superimposing the transmission information and the ATPC indication information, and generates a modulation signal. Thereafter, the process proceeds to step S153.

(Step S153)

The transmission unit 11 converts the modulation signal generated in step S152 into an RF signal, and outputs the RF signal to the antenna 4. Thereafter, the process proceeds to step S154.

(Step S154)

The antenna 4 transmits the RF signal to the second wireless station 200. Thereafter, the process proceeds to step S155.

(Step S155)

The antenna 3 receives the RF signal transmitted from the first wireless station 100, and outputs the received RF signal to the reception unit 12. Thereafter, the process proceeds to step S156.

(Step S156)

The reception unit 12 converts the RF signal input in step S155 into a baseband signal. Thereafter, the process proceeds to step S157.

(Step S157)

The demodulation unit 13 demodulates the baseband signal obtained by the conversion in step S156 into transmission information. The demodulation unit 13 extracts control information from the transmission information. Thereafter, the process proceeds to step S158.

(Step S158)

The ATPC indication information extraction unit 14 extracts ATPC indication information from the control information extracted in step S157. Thereafter, the process proceeds to step S159.

(Step S159)

The transmission unit 2 converts the modulation signal input from the modulation unit 1 into an RF signal with strength indicated by the ATPC indication information extracted in step S158, and outputs the RF signal to the antenna 3. Thereafter, the process proceeds to an end process.

In this manner, according to the first embodiment, in the wireless communication system including the first wireless station 100 and the second wireless station 200, the second wireless station 200 includes the D/U calculation unit 7 which calculates a D/U ratio of a baseband signal of a signal received from the first wireless station 100 and the ATPC indication information creation unit 9 which generates transmission strength indication information indicating transmit power of the first wireless station 100 based on a history of the D/U ratio calculated by the D/U calculation unit 7, and the first wireless station 100 includes the transmission unit 2 which controls the transmit power based on the SNR.

Thereby, in the first embodiment of the present invention, it is possible to vary an output of the transmitter from the D/U ratio estimated according to a received signal, and perform communication using a maximum output of the transmitter capable of being implemented without degrading a D/U ratio of a signal according to a state of a wireless communication path.

In addition, because the D/U ratio is calculated in a receiver side in the first embodiment, the system can be configured at a lower cost compared to a wireless communication device of the related art having a circuit which calculates the D/U ratio in a transmitter side.

### Second Embodiment

Hereinafter, the second embodiment of the present invention will be described in detail with reference to the drawings.

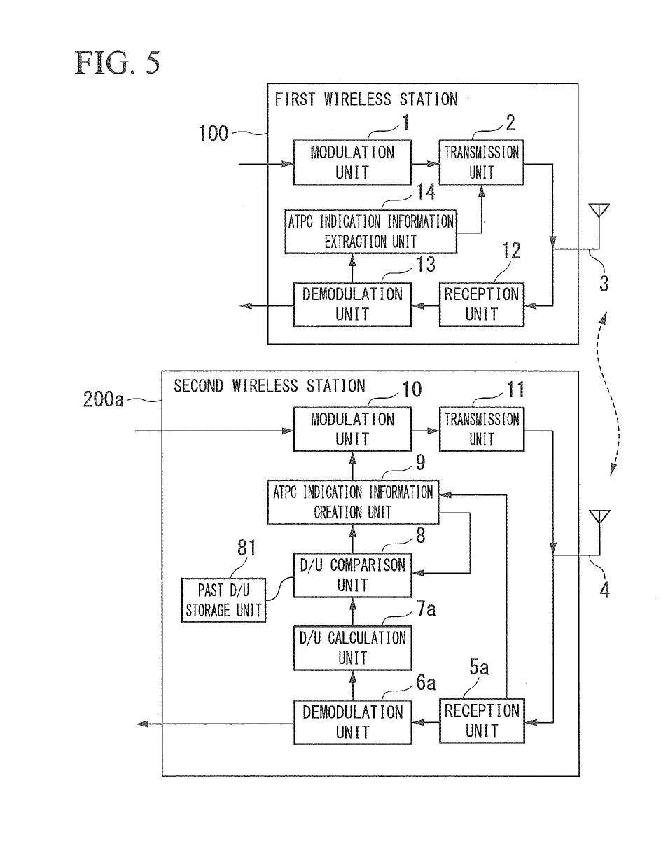

FIG. 5 is a block diagram illustrating a wireless communication system 1b according to the second embodiment of the present invention. The wireless communication system 1b (FIG. 5) according to the second embodiment includes the first wireless station 100 and a second wireless station 200a.

When the wireless communication system 1b according to the second embodiment and the wireless communication system 1a (FIG. 1) according to the first embodiment are compared, a reception unit 5a, a demodulation unit 6a, and a D/U calculation unit 7a are different. However, functions provided in the other components are the same as in the first embodiment. A description of the same functions as in the first embodiment is omitted here.

The reception unit 5a converts an RF signal input from the antenna 4 into a baseband signal, and outputs the baseband signal obtained by the conversion to the demodulation unit 6a. The reception unit 5a measures the strength of the RF signal received by the antenna 4, and outputs a received electric field strength signal indicating the measured strength to the ATPC indication information creation unit 9.

The demodulation unit 6a demodulates the baseband signal input from the reception unit 5a into transmission information. The demodulation unit 6a outputs signal point error information indicating an error (signal point error) in a distance between a signal point actually obtained by demodulating the baseband signal on a signal space diagram and an original signal point to the D/U calculation unit 7a. The demodulation unit 6a outputs the demodulated transmission information.

The D/U calculation unit 7a calculates a D/U ratio based on a magnitude of the signal point error indicated by the signal point error information input from the demodulation unit 6a. Specifically, a table indicating a relationship between a signal point error and a D/U ratio actually measured in advance is stored in the D/U calculation unit 7a, and a D/U ratio corresponding to the signal point error input from the demodulation unit 6a is extracted.

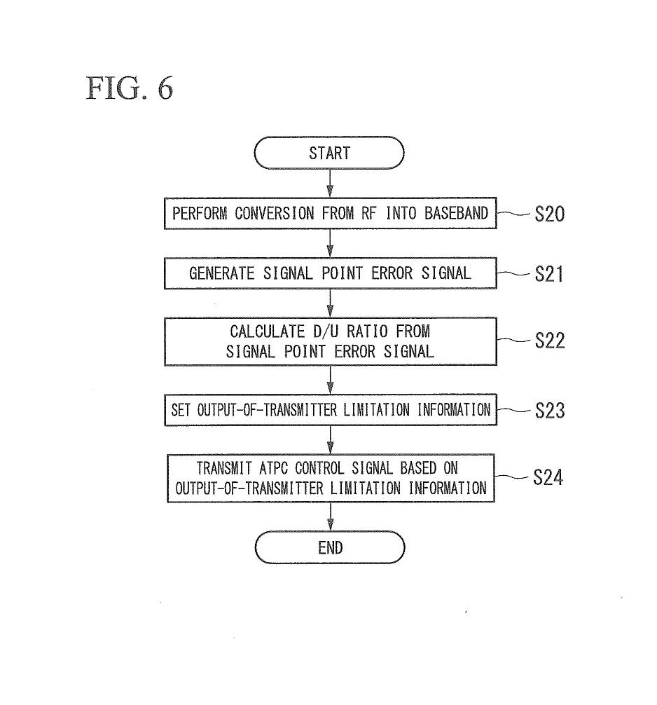

FIG. 6 is a flowchart illustrating an example of an operation according to the second embodiment.

In the second embodiment, the process proceeds to step S20 after the same processes as steps S10 and S11 of the first embodiment illustrated in FIG. 2 are performed.

(Step S20)

The reception unit 5a converts the RF signal input from the antenna 4 into a baseband signal. The reception unit 5a measures a received electric field strength signal indicating the strength of the RF signal received by the antenna 4. Thereafter, the process proceeds to step S21.

(Step S21)

The demodulation unit 6a demodulates the baseband signal obtained by the conversion in step S20 into transmission information. The demodulation unit 6a generates signal point error information indicating an error (signal point error) in a distance between a signal point obtained by the demodulation and a logical signal point. The demodulation unit 6a outputs the transmission information obtained by the demodulation. Thereafter, the process proceeds to step S22.

(Step S22)

The D/U calculation unit 7a calculates the D/U ratio based on a magnitude of the signal point error indicated by the signal point error information generated in step S21. Specifically, a table indicating a relationship between a signal point error and a D/U ratio actually measured in advance is stored in the D/U calculation unit 7a, and a D/U ratio corresponding to the signal point error generated in step S21 is read from the table. Thereafter, the process proceeds to step S23.

The respective processes of steps S23 and S24 are similar to those of steps S14 and S15 in the first embodiment.

In this manner, according to the second embodiment, a D/U ratio is calculated from the signal point error calculated by the demodulation unit 6a. Thereby, it is possible to calculate the D/U ratio in a small calculation amount compared to when the D/U ratio is calculated using frequency conversion such as FFT.

Although the D/U ratio has been calculated using the table indicating the relationship between a signal point error and a D/U ratio actually measured in advance in the second embodiment, an equation indicating the relationship between the signal point error and the D/U ratio may be stored in the D/U calculation unit 7a and the D/U ratio may be calculated by substituting the signal point error input from the demodulation unit 6a into the equation.

### Third Embodiment

Hereinafter, the third embodiment of the present invention will be described in detail with reference to the drawings.

The third embodiment is different from the first and second embodiments in that output-of-transmitter information and transmission path information are used in addition to the D/U ratio when an output-of-transmitter limitation signal is generated.

Here, the generation of the output-of-transmitter limitation signal using the output-of-transmitter information and the generation of the output-of-transmitter limitation signal using the transmission path information will be described.

The generation of the output-of-transmitter limitation signal using the output-of-transmitter information will be described. In the wireless station device, variation occurs in the distortion characteristics due to a temperature, an individual difference of the wireless station device, or the like. Here, a wireless device having a worst distortion characteristic which is assumed to occur in the wireless station device is considered. In this wireless device, there is a threshold value α of an output of the transmitter which is a maximum output of the transmitter at which the distortion characteristic does not deteriorate anymore even when it is supplied. The output-of-transmitter determination unit 15 to be described later generates an output-of-transmitter limitation signal which does not limit an increase in power because the distortion characteristics do not directly deteriorate according to an increase in an output of the transmitter if the current output of the transmitter is less than α. On the other hand, because the distortion characteristic further deteriorates with an increase in an output of the transmitter if the current output of the transmitter is greater than α, it is difficult to directly increase power. In this case, when the output of the transmitter is changed, the output-of-transmitter determination unit 15 causes the D/U comparison unit 8b to make a further determination using the D/U ratio.

The generation of the output-of-transmitter limitation signal using the transmission path information will be described. The reception unit 5b includes a function of compensating for variation in the transmission path characteristics (transmission path information). A maximum value of variation in the transmission path information capable of being compensated for by the reception unit 5b is assumed to be a threshold value β. If the variation in the transmission path information is less than β and the variation in the transmission path information is in a range in which compensation by the reception unit 5b is possible when the D/U ratio has deteriorated, it is possible to determine that the increase in the output of the transmitter is the cause of deterioration in the transmission path information. In this case, the transmission path information comparison unit 17 to be described later outputs the output-of-transmitter limitation signal to decrease an output of the transmitter. On the other hand, in a situation in which the variation in the transmission path information is greater than β and it is difficult for the reception unit 5b to compensate for the variation in the transmission path information, it is difficult to determine whether the D/U ratio has deteriorated due to an increase in the output of the transmitter or the D/U ratio has deteriorated due to variation in the transmission path information. In this case, the transmission path information comparison unit 17 generates the output-of-transmitter limitation signal to maintain the current output of the transmitter.

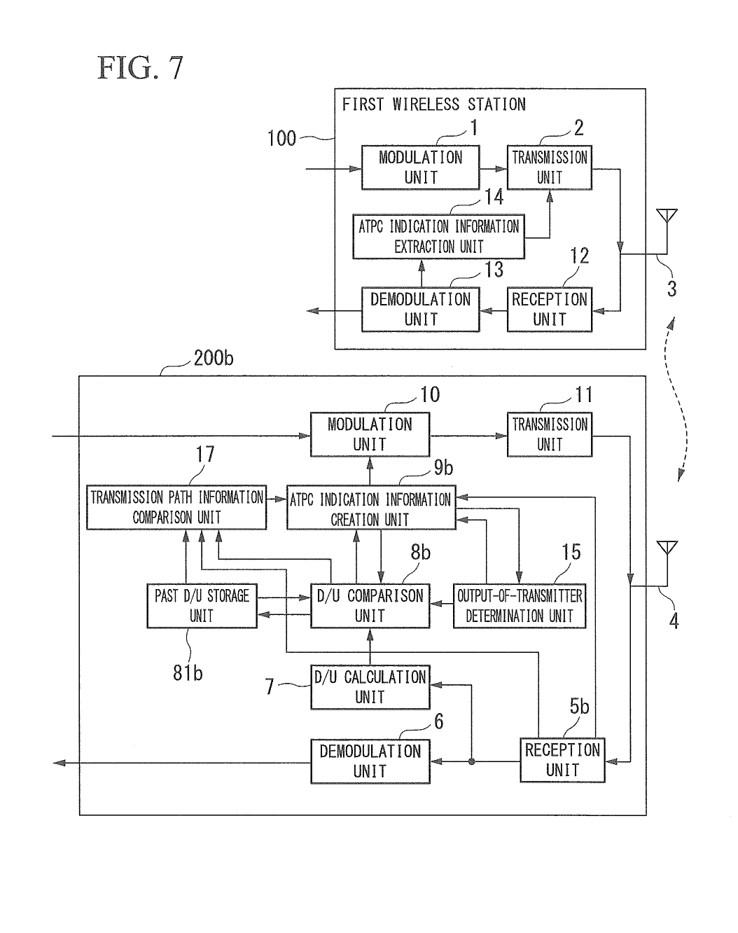

FIG. 7 is a block diagram illustrating a wireless communication system 1c according to a third embodiment of the present invention. The wireless communication system 1c (FIG. 5) according to the third embodiment includes the first wireless station 100 and a second wireless station 200b.

When the wireless communication system 1c according to the third embodiment and the wireless communication system 1a (FIG. 1) according to the first embodiment are compared, a reception unit 5b, an output-of-transmitter determination unit 15, a D/U comparison unit 8b, a transmission path information comparison unit 17, an ATPC indication information creation unit 9b, and a past D/U storage unit 81b are different.

However, functions provided in the other components are the same as in the first embodiment. Descriptions of the same functions as in the first embodiment are omitted here.

The reception unit 5b converts an RF signal input from the antenna 4 into a baseband signal, and outputs the baseband signal obtained by the conversion to the demodulation unit 6 and the D/U calculation unit 7. The reception unit 5b outputs a received electric field strength signal indicating the strength of the RF signal received by the antenna 4 to the ATPC indication information creation unit 9b. The reception unit 5b generates fading state information which is transmission path information based on a tap coefficient of a transversal equalizer to be used to compensate for transmission path loss in a process of converting the RF signal into a baseband signal. The fading state information is represented by a sum of tap coefficients. In the third embodiment, transmission path quality is indicated to be good if a value indicated by the transmission path information is large and indicated to be bad if the value indicated by the transmission path information is small. The reception unit 5b outputs the transmission path information to the transmission path information comparison unit 17.

The output-of-transmitter determination unit 15 receives the ATPC indication information from the ATPC indication information creation unit 9b. The output-of-transmitter determination unit 15 compares the above-described predetermined threshold value α to a current output of the transmitter indicated by the ATPC indication information. When the current output of the transmitter is less than the threshold value α, output-of-transmitter limitation information which does not limit an increase in power is output to the ATPC indication information creation unit 9b. When the current output of the transmitter is greater than the threshold value α, D/U ratio-power comparison signals for comparing current and past D/U ratios and current and past transmit powers are output to the D/U comparison unit 8b.

The D/U comparison unit 8b reads the past D/U ratio and the past output of the transmitter from the past D/U storage unit 81b. Upon determining that the current output of the transmitter input from the ATPC indication information creation unit 9b is greater than the past output of the transmitter and the current D/U ratio indicated by the ATPC indication information input from the D/U calculation unit 7 is greater than the past D/U ratio, the D/U comparison unit 8b outputs output-of-transmitter limitation information, which does not limit an increase in power, to the ATPC indication information creation unit 9b. Upon determining that the current output of the transmitter is greater than the past output of the transmitter and the current D/U ratio is less than the past D/U ratio, the D/U comparison unit 8b outputs a transmission path determination signal for determining variation in transmission path information to the transmission path information comparison unit 17.

When the transmission path determination signal is input from the D/U comparison unit 8b, the transmission path information comparison unit 17 performs the following operation. The transmission path information comparison unit 17 receives transmission path information from the reception unit 5b. The transmission path information comparison unit 17 reads the past transmission path information from the past D/U storage unit 81b. The transmission path information comparison unit 17 calculates a transmission difference which is the difference between the current transmission path information and the past transmission path information, and outputs the output-of-transmitter limitation signal to increase the output of the transmitter to the ATPC indication information creation unit 9b when the transmission difference is less than the predetermined threshold value β. When the transmission difference is greater than the predetermined threshold value β, the output-of-transmitter limitation signal to maintain the current output of the transmitter is output to the ATPC indication information creation unit 9b.

The ATPC indication information creation unit 9b receives received electric field strength information from the reception unit 5b. The ATPC indication information creation unit 9b receives and outputs the output-of-transmitter limitation information from the output-of-transmitter determination unit 15. The ATPC indication information creation unit 22 receives and outputs the output-of-transmitter limitation information from the D/U comparison unit 8b. The ATPC indication information creation unit 9b receives the output-of-transmitter limitation information from the transmission path information comparison unit 17. Based on the input output-of-transmitter limitation information and received electric field strength information, the ATPC indication information creation unit 9b generates ATPC indication information, and outputs the generated ATPC indication information to the modulation unit 10, the output-of-transmitter determination unit 15, and the D/U comparison unit 8b.

The past D/U storage unit 81b stores a table in which a past D/U ratio, a past output of the transmitter, and past transmission path information are associated. When the number of records of the stored table has exceeded a predetermined number, the past D/U storage unit 81b deletes old records corresponding to an excess of records beyond the predetermined number, and holds a predetermined number of records.

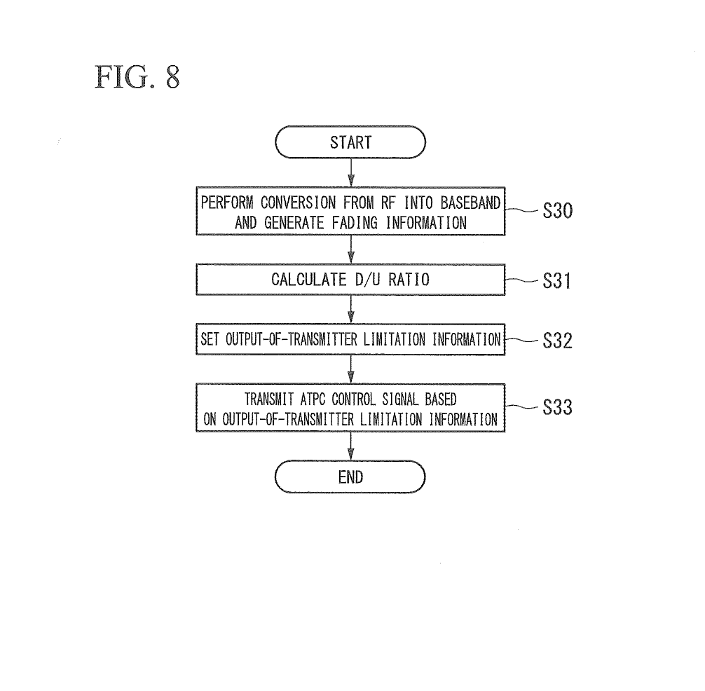

FIG. 8 is a flowchart illustrating an example of an operation according to the third embodiment of the present invention. In the third embodiment, the process proceeds to step S30 after steps S10 and S11 of the first embodiment illustrated in FIG. 2.

(Step S30)

The reception unit 5b converts an RF signal input from the antenna 4 into a baseband signal. The reception unit 5b measures the strength of the RF signal received by the antenna 4 (received electric field strength). The reception unit 5b generates fading state information (transmission path information) indicated by a sum of tap coefficients based on tap coefficients of a transversal equalizer to be used to compensate for transmission path loss in a process of converting the RF signal into a baseband signal. Thereafter, the process proceeds to step S31.

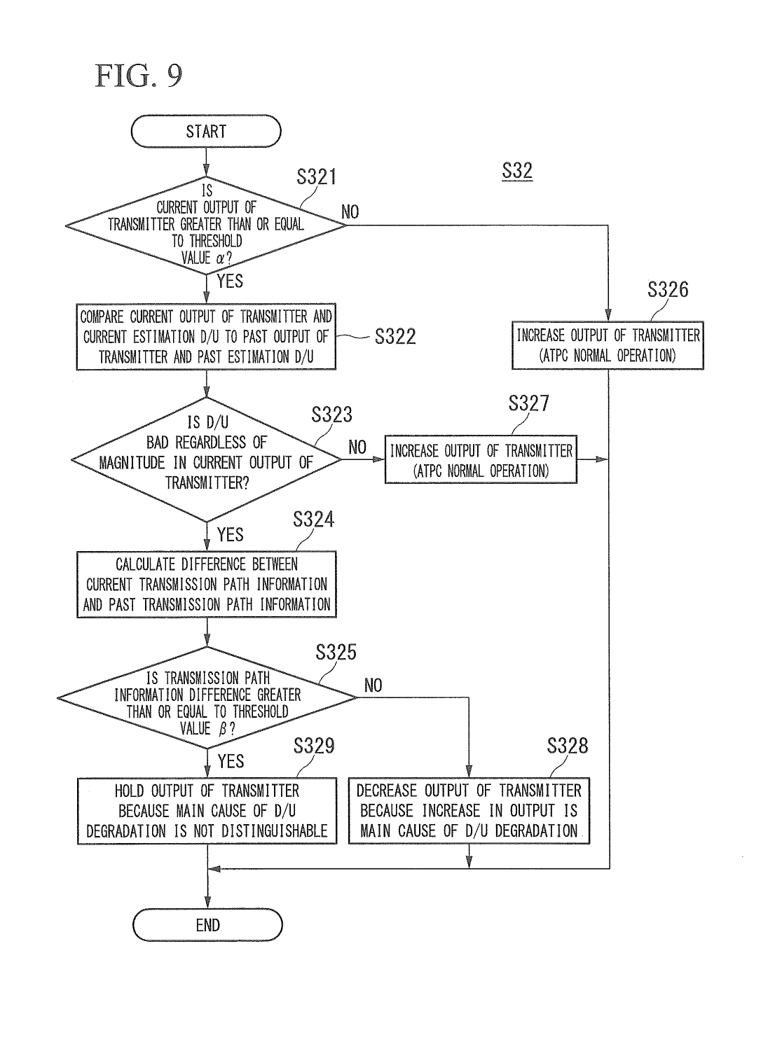

Because the respective processes of steps S31 and S33 are similar to those of steps S13 and S15 (see FIG. 2) in the first embodiment, description thereof is omitted. The process of step S32 will be described later in detail using FIG. 9.

FIG. 9 is a flowchart illustrating an example of an operation according to the third embodiment of the present invention.

(Step S321)

The output-of-transmitter determination unit 15 determines whether a current output of the transmitter indicated by the ATPC indication information generated in step S328 or S329 is greater than the predetermined threshold value α. When it is determined that the current output of the transmitter is greater than the threshold value α (Yes), D/U ratio-power comparison signals used to compare current and past D/U ratios and current and past powers of the transmitter are output to the D/U comparison unit 8b. Thereafter, the process proceeds to step S322. When it is determined that the current output of the transmitter is less than the threshold value α (No), the process proceeds to step S326.

(Step S322)

The D/U comparison unit 8b receives the D/U ratio-power comparison signals from the output-of-transmitter determination unit 15 and performs the following operation. The D/U comparison unit 8b reads the past output-of-transmitter information from the past D/U storage unit 81b. The D/U comparison unit 8b calculates a value ΔP obtained by subtracting the past output of the transmitter indicated by the past output-of-transmitter information from the current output of the transmitter indicated by generated ATPC indication information in step S328 or S329.

The D/U comparison unit 8b reads the past D/U ratio information from the past D/U storage unit 81b. A value Δ(D/U) obtained by subtracting the past output of the transmitter indicated by the past D/U ratio information from the current output of the transmitter indicated by the D/U ratio information generated in step S31 is calculated. Thereafter, the process proceeds to step S323.

(Step S323)

The D/U comparison unit 8b determines whether ΔP calculated in step S322 is positive and Δ(D/U) is positive. When it is determined that ΔP is positive and Δ(D/U) is positive (Yes), the transmission path determination signal is output to the transmission path information comparison unit 17. Thereafter, the process proceeds to step S324. Otherwise (No), the process proceeds to step S327.

(Step S324)

The transmission path information comparison unit 17 receives the transmission path determination signal output in step S323, and performs the following operation. The transmission path information comparison unit 17 reads the past transmission path information from the past D/U storage unit 81b. The transmission path information comparison unit 17 calculates a value ΔW obtained by subtracting the past transmission path information from the current transmission path information generated in step S30. Thereafter, the process proceeds to step S325.

(Step S325)

The transmission path information comparison unit 17 determines whether the pre-stored threshold value β is greater than ΔW calculated in step S324. When it is determined that ΔW is greater than β (Yes), the process proceeds to step S328. When it is determined that ΔW is less than β (No), the process proceeds to step S329.

(Step S326)

The output-of-transmitter determination unit 15 outputs the output-of-transmitter limitation information, which does not limit the increase in power, to the ATPC indication information creation unit 9b. Thereafter, the process proceeds to step S49 (not illustrated). Here, the process of step S49 is similar to the process of step S15 in the first embodiment.

(Step S327)

The D/U comparison unit 8b outputs the output-of-transmitter limitation information, which does not limit the increase in power, to the ATPC indication information creation unit 9b. Thereafter, the process proceeds to step S49.

(Step S328)

The ATPC indication information creation unit 9b receives output-of-transmitter limitation information to decrease power from the transmission path information comparison unit 17, and generates ATPC indication information indicating a decreased value of the output of the transmitter. Thereafter, the process proceeds to step S49.

(Step S329)

The ATPC indication information creation unit 9b receives output-of-transmitter limitation information to maintain power from the transmission path information comparison unit 17, and generates ATPC indication information indicating a held value of the output of the transmitter. Thereafter, the process proceeds to step S49.

Here, the process of step S49 is similar to the process of step S15 of the first embodiment.

In this manner, according to the third embodiment of the present invention, there are provided an output-of-transmitter determination unit which generates transmission strength indication information based on a transmission output of the transmitter and a transmission path information comparison unit which generates the transmission strength indication information based on variation in transmission path information. Thereby, it is possible to distinguish D/U radio degradation due to an increase in an output of the transmitter and D/U ratio degradation due to transmission path degradation and execute an ATPC process based on an actual state of distortion characteristics of a wireless communication device. Therefore, it is possible to further improve communication quality.

Also, instead of fading state information, received electric field strength may be used in the transmission path information.

Although the first, second, and third embodiments of the present invention have been described above in detail with reference to the drawings, specific configurations are not limited to these embodiments, and various designs can be made without departing from the scope of the present invention.

### INDUSTRIAL APPLICABILITY

According to a wireless communication system according to the present invention, an output of a transmitter can be increased without degrading an SNR.

Priority is claimed on Japanese Patent Application No. 2011-128011, filed Jun. 8, 2011, the content of which is incorporated herein by reference.

### [Description of Reference Symbols]

1 Modulation unit

1a Wireless communication system

1b Wireless communication system

1c Wireless communication system

2 Transmission unit

3 Antenna

4 Antenna

5 Reception unit

5a Reception unit

5b Reception unit

6 Demodulation unit

6a Demodulation unit

7 D/U calculation unit

7a D/U calculation unit

8 D/U comparison unit

8b D/U comparison unit

9 ATPC indication information creation unit

9b ATPC indication information creation unit

10 Modulation unit

11 Transmission unit

12 Reception unit

13 Demodulation

14 ATPC indication information extraction unit

81 Past D/U storage unit

81b Past D/U storage unit

100 First wireless station

200 Second wireless station

200a Second wireless station

200b Second wireless station

1. A wireless communication system comprising:
a transmitter and a receiver,
wherein the receiver comprises:
a signal-to-noise ratio (SNR) calculation unit which calculates a SNR of a baseband signal of a signal received from the transmitter; and
an indication information generation unit which generates transmission strength indication information indicating transmit power of the transmitter based on a history of the SNR calculated by the SNR calculation unit, and
wherein the transmitter comprises:
a transmission unit which controls the transmit power based on the SNR.

2. The wireless communication system according to claim 1,
wherein the receiver includes:
an antenna which transmits and receives radio waves to and from the transmitter;
a reception unit which converts the radio waves received by the antenna into a baseband signal;
a storage unit which stores past SNR and past transmission strength indication information;
an SNR comparison unit which compares a current SNR and current transmission strength indication information to the past SNR and the past transmission strength indication information; and
an indication information generation unit which generates transmission strength indication information indicating the transmit power of the transmitter based on a comparison result of the SNR comparison unit,
wherein the transmitter includes:
an indication information extraction unit which acquires the transmission strength indication information generated by the receiver, and
wherein the transmission unit controls the transmit power based on the transmission strength indication information input from the indication information extraction unit.

3. The wireless communication system according to claim 1, wherein the SNR calculation unit calculates the SNR based on a signal after a Fourier transform on the baseband signal.

4. The wireless communication system according to claim 1, further comprising:
a demodulation unit which demodulates the baseband signal,
wherein the SNR calculation unit calculates the SNR based on a signal point error of a signal demodulated by the demodulation unit.

5. The wireless communication system according to claim 1, further comprising:
an output-of-transmitter determination unit which generates the transmission strength indication information based on a transmission output of the transmitter.

6. The wireless communication system according to claim 1, further comprising:
a transmission path information comparison unit which generates the transmission strength indication information based on variation in transmission path information.

7. A receiver comprising:
an SNR calculation unit which calculates an SNR of a baseband signal of a signal received from a transmitter; and
an indication information generation unit which generates transmission strength indication information indicating transmit power of the transmitter based on a history of the SNR calculated by the SNR calculation unit.
